(19) United States
(12) Patent Application Publication
(10) Pub. No.: US 2019/0360421 A1
(43) Pub. Date: Nov. 28, 2019

(54) METHOD TO EVALUATE THE INSTANTANEOUS FUEL TO TORQUE ICE EFFICIENCY STATUS

(71) Applicant: GM Global Technology Operations LLC, Detroit, MI (US)

(72) Inventors: Angelo Cancellieri, Torino (IT); Paul Leonardo Claude, Torino (IT); Pietro Orlando, Torino (IT); Andrea Morgando, Borgiallo (IT)

(21) Appl. No.: 15/988,323

(22) Filed: May 24, 2018

(51) Int. Cl. F02D 41/30; F02B 77/08; F02D 9/10; F02D 41/14; F02M 57/00

(52) U.S. Cl. CPC F02D 41/30; F02B 77/085; F02D 9/105; F02D 41/144; F02M 2200/248; F02M 57/005; F02D 2200/602; F02M 2200/247; F02D 41/1454

(57) ABSTRACT

A method of determining combustion efficiency in an engine includes utilizing a control module having a computer memory, a processor, and inputs and outputs, the processor executing logic stored within the memory, sensing data by first sensors disposed on the engine and second sensors disposed in an exhaust system fluidly coupled to the engine, the first and second sensors electrically connected to the inputs, receiving within the control module data sensed by the first and the second sensors; determining an oxygen content of air entering the engine, determining an oxygen content of exhaust upstream of an oxidation catalyst; determining a fuel latent heat of vaporization; determining a fuel injection quantity to combust with oxygen entering the engine; determining a combustion efficiency index based on the oxygen content of air entering the engine and in the exhaust, and the latent heat of vaporization of fuel; and adjusting a fuel injection quantity.

### INTRODUCTION

The present disclosure relates to internal combustion engines (ICEs). More specifically, the present disclosure relates to systems and methods to determine heat release and transfer based on sensed operating parameters of from a variety of ICE sensors. Emissions standards, environmental concerns, as well as operator perceptions of responsiveness dictate many of the ways in which combustion in typical ICEs is controlled. Of particular interest in pursuit of lowering emissions, environmental standards, and responsiveness is the concept of combustion efficiency. Combustion efficiency is a measure of how well the fuel being burned in the ICE is being utilized in the combustion process. In other words, combustion efficiency is a measurement of how effectively the fuel being burned in the engine is being converted into torque rather than into heat. Measuring combustion efficiency directly is difficult, if not impossible. Therefore, indirect measurements of combustion efficiency are typically relied upon. While it is not impossible to place combustion sensors, such as thermocouples, directly in the combustion chamber(s) of ICEs, it can be quite expensive to do so, especially on a large or mass production scale. Moreover, most such sensors rapidly degrade when so placed. As a result, most ICEs detect and direct combustion based on readings from a suite of sensors that provide indirect evidence of combustion characteristics. Combustion efficiency in a typical ICE system is often calculated based on a known commanded fuel quantity, an intake mass air flow measurement and an intake air temperature measurement. However sensors and actuators, like everything else, are subject to aging effects. As sensors age, their readings become less accurate, precise, and reliable. Similarly, as actuators such as fuel injectors age, they become less accurate, precise, and reliable. As a result, as an ICE with its sensors and actuators ages, calculations of combustion efficiency can become less reliable. As the reliability of combustion efficiency calculations decreases, eventually the ICE may operate in such a manner that does not comply with regulatory standards.

Thus, while current methods of detecting combustion efficiency are generally effective for their intended purpose, there is a need for a new and improved system and method that increases the robustness of combustion efficiency calculations so that such calculations can account for sensor and actuator aging effects and drift over time.

### SUMMARY

According to several aspects of the present disclosure a method of determining combustion efficiency in an internal combustion engine (ICE) includes utilizing a control module having a plurality of inputs, a plurality of outputs, a computer readable memory, and a processor, the processor configured to execute programmatic logic stored within the computer readable memory. The method further includes sensing data by a first plurality of sensors disposed on the ICE and electrically connected to the plurality of inputs of the control module, and by a second plurality of sensors electrically connected to the plurality of inputs of the control module and disposed in an exhaust system fluidly coupled to the ICE, receiving within the control module data sensed by the first and the second plurality of sensors, and determining an oxygen (O2) content of air entering the ICE and determining an O2 content of exhaust upstream of an oxidation catalyst. The method further includes determining a latent heat of vaporization of fuel, determining a fuel injection quantity required to be combusted with the O2 sensed in the air entering the ICE, determining a combustion efficiency index based on the O2 content of the air entering the ICE, the O2 content of the exhaust upstream of the oxidation catalyst, and the latent heat of vaporization of the fuel; and adjusting a fuel injection quantity.

In another aspect of the present disclosure determining an O2 content of air entering the ICE further includes utilizing a mass air flow sensor of the first plurality of sensors to detect an amount of air entering the ICE.

In yet another aspect of the present disclosure determining an O2 content of air entering the ICE further includes utilizing a manifold absolute pressure (MAP) sensor of the first plurality of sensors to detect an amount of air entering the ICE.

In yet another aspect of the present disclosure determining an O2 content of the exhaust further includes utilizing an oxygen sensor of the second plurality of sensors to detect an O2 content of the exhaust upstream of the oxidation catalyst.

In yet another aspect of the present disclosure determining a latent heat of vaporization of the fuel further includes utilizing a fuel temperature sensor of the first plurality of sensors, the fuel temperature sensor disposed in a fuel line of the ICE to sense a temperature of the fuel entering the ICE.

In yet another aspect of the present disclosure a method of determining combustion efficiency in an internal combustion engine (ICE) of further includes determining a load condition of the ICE.

In yet another aspect of the present disclosure determining a load condition of the ICE further includes receiving an input from several of the first plurality of sensors, including a throttle position sensor (TPS), and an accelerator pedal position (APP) sensor, and determining whether the ICE is operating in a loaded condition or in a cut-off condition.

In yet another aspect of the present disclosure determining a load condition of the ICE further includes determining whether a combustion chamber temperature is above a predetermined threshold temperature as a function of intake temperature, mass air flow, and exhaust gas temperature.

In yet another aspect of the present disclosure when the engine is operating in a loaded condition, calculating a gain by integrating an actual fuel injection quantity as a function of engine revolution, and the actual fuel injection quantity is estimated as a function of mass air flow and O2 concentration in the exhaust.

In yet another aspect of the present disclosure when the engine is operating in a cut-off condition, calculating a gain by integrating an actual fuel injection quantity as a function of engine revolution, and the actual fuel injection quantity is zero and the gain is a function of mass air flow and intake air temperature.

In yet another aspect of the present disclosure a system for determining combustion efficiency in an internal combustion engine (ICE) includes a control module executing control logic and having a plurality of inputs and a plurality of outputs. The plurality of inputs and the plurality of outputs are electronically connected to a first plurality of sensors and actuators disposed on the ICE, and the plurality of inputs and the plurality of outputs are electronically connected to a second plurality of sensors and actuators disposed on an exhaust system fluidly coupled to the ICE. The control logic includes a first control logic for receiving data sensed by the first and the second plurality of sensors and actuators, a second control logic for determining an oxygen (O2) content of air entering the ICE and determining an O2 content of exhaust upstream of an oxidation catalyst, a third control logic for determining a latent heat of vaporization of fuel, a fourth control logic for determining a combustion efficiencyindex based on the O2 content entering the IC, the O2 content of the exhaust upstream of the oxidation catalyst, and the latent heat of vaporization of the fuel, and a fifth control logic for adjusting a fuel injection quantity based on the combustion efficiency index.

In yet another aspect of the present disclosure the second control logic further includes utilizing a mass air flow sensor (MAF) or a manifold absolute pressure (MAP) sensor to detect an amount of air entering the ICE.

In yet another aspect of the present disclosure the second control logic further includes utilizing an oxygen sensor to detect an O2 content of the exhaust upstream of the oxidation catalyst.

In yet another aspect of the present disclosure the third control logic further includes utilizing a fuel temperature sensor disposed in a fuel line of the ICE to sense a temperature of the fuel entering the ICE.

In yet another aspect of the present disclosure the system for determining combustion efficiency in an internal combustion engine (ICE) further includes a sixth control logic determining a load condition of the ICE.

In yet another aspect of the present disclosure the sixth control logic further includes receiving an input from a throttle position sensor (TPS) and an accelerator pedal position (APP) sensor, and determining whether the ICE is operating in a load condition or in a cut-off condition.

In yet another aspect of the present disclosure the sixth control logic further includes determining whether a combustion chamber temperature is above a predetermined threshold temperature as a function of intake air temperature, mass air flow, and exhaust gas temperature.

In yet another aspect of the present disclosure the sixth control logic further includes when the ICE is operating in the load condition, calculating a gain by integrating an actual fuel injection quantity as a function of engine revolution, wherein the actual fuel injection quantity is estimated as a function of mass air flow and O2 concentration in the exhaust.

In yet another aspect of the present disclosure the sixth control logic further includes when the ICE is operating in a cut-off condition, calculating a gain by integrating an actual fuel injection quantity as a function of engine revolution, wherein the actual fuel injection quantity is zero and the gain is a function of mass air flow and intake air temperature.

In yet another aspect of the present disclosure a system for determining combustion efficiency in an internal combustion engine (ICE) of a propulsion system includes a control module executing control logic and having a plurality of inputs and a plurality of outputs. The plurality of inputs and the plurality of outputs are electronically connected to a first plurality of sensors and actuators disposed on the ICE, and the plurality of inputs and the plurality of outputs are electronically connected to a second plurality of sensors and actuators disposed on an exhaust system fluidly coupled to the ICE. The control logic includes a first control logic for receiving data sensed by the first and the second plurality of sensors and actuators, a second control logic for utilizing a mass air flow sensor (MAF) or a manifold absolute pressure sensor (MAP) to determine an oxygen (O2) content of air entering the ICE and for utilizing an oxygen sensor to detect an O2 content of the exhaust upstream of the oxidation catalyst, a third control logic for utilizing a fuel temperature sensor disposed in a fuel line of the ICE to sense a temperature of fuel entering the ICE and for determining a latent heat of vaporization of the fuel, a fourth control logic for determining a combustion efficiency index based on the O2 content entering the IC, the O2 content of the exhaust upstream of the oxidation catalyst, and the latent heat of vaporization of the fuel, a fifth control logic for adjusting a fuel injection quantity based on the combustion efficiency index, a sixth control logic for receiving an input from a throttle position sensor (TPS) and an accelerator pedal position (APP) sensor, and determining whether the ICE is operating in a load condition or in a cut-off condition, wherein when the ICE is operating in a load condition, calculating a gain by integrating an actual fuel injection quantity as a function of engine revolution, wherein actual fuel injection quantity is estimated as a function of mass air flow and O2 concentration in the exhaust, and a seventh control logic for determining whether a combustion chamber temperature is above a predetermined threshold temperature as a function of intake air temperature, mass air flow, and exhaust gas temperature.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic illustration of a motor vehicle powertrain system according to an aspect of the present disclosure;

FIG. 2 is a diagram of a portion of a method for evaluating the instantaneous fuel to torque efficiency status of an internal combustion engine according to an aspect of the present disclosure; and

FIG. 3 is a flowchart depicting the method for evaluating the instantaneous fuel to torque efficiency status of an internal combustion engine according to an aspect of the present disclosure.

### DETAILED DESCRIPTION

The following description is merely exemplary in nature and is not intended to limit the present disclosure, application, or uses. For purposes of clarity, the same reference numbers will be used in the drawings to identify similar elements.

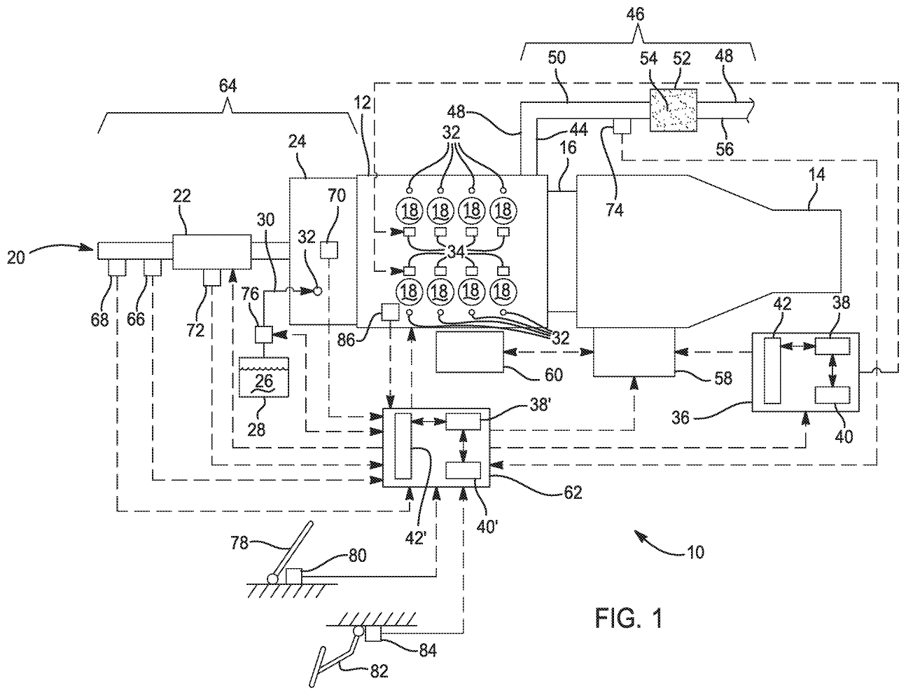

Referring to FIG. 1, a powertrain system is shown and indicated generally by reference number 10. In several aspects, the powertrain system 10 is equipped to a motor vehicle (not shown). The motor vehicle may be a car, a truck, an SUV, a van, a semi, a tractor, a bus, a go-kart, or any other such motor vehicle without departing from the scope or intent of the present disclosure. The powertrain system 10 is equipped with an engine 12 that drives a transmission 14. In one example, the engine 12 is an internal combustion engine (ICE) 12, such as a gasoline-powered engine, however the engine 12 may be a diesel engine, a compressed natural gas (CNG) engine, a propane engine, or any other such internal combustion engine. The transmission 14 may be a manual, automatic, multi-clutch, or continuously variable transmission, or any other type of electronically, pneumatically, and/or hydraulically-controlled transmission that is driven by the engine 12 through a corresponding torque converter or clutch 16. The transmission 14 may be manual, automatic, multi-clutch, or continuously variable, or any other type of electronically, pneumatically, and/or hydraulically-controlled automotive transmission 14 without departing from the scope or intent of the present disclosure. The engine 12 includes a plurality of cylinders 18. It should be understood that while in the example of FIG. 1, the engine 12 includes eight cylinders, the engine 12 may include any quantity from 1 to 16 cylinders 18. For example, engines having 1, 2, 3, 4, 5, 6, 8, 10, 12, and 16 cylinders are contemplated. In some examples, the engine 12 may be a rotary engine. In rotary engines 12, the cylinders 18 may more accurately be described as rotary piston housings (not shown). Thus, in the example of a rotary engine 12, there may be any quantity from 1 to 6 rotary piston housings.

Air 20 flows into the engine 12 through a throttle 22 via an intake manifold 24. The air 20 is combined with fuel 26 and combusted within the cylinders 18. The fuel 26 is drawn from a fuel reservoir or tank 28 via a fuel line 30. Fuel injectors 32 draw fuel 26 from the fuel line or lines 30, and inject or spray the fuel 26 into the engine 12. In a first example, known as a port-injected (PI) engine 12, the engine 12 includes at least one fuel injector 32 mounted to the intake manifold 22. The fuel 26 is then drawn into the cylinders 18 where the fuel 26 is combined with the air 20 and ignited by an electrical spark generated by a spark plug 34. In a second example, the engine 12 may be described as a direct injection (DI) engine having a plurality of fuel injectors 26 mounted directly to the engine 12 and injecting fuel 26 directly into the cylinders 18 where the fuel 26 is mixed with air 20 and ignited by an electrical spark generated by the spark plug 34. In yet a further example, the engine 12 may include both injectors 32 mounted to the intake manifold 22 and injectors 32 mounted directly to the engine 12 and injecting fuel directly into the cylinders 18 of the engine 12. In some examples, the engine 12 has a single spark plug 34 for each cylinder 18. In further examples, the engine 12 has multiple spark plugs 34 for each cylinder 18. While the engine 12 has been described as having one or two spark plugs 34 for each cylinder 18, it should be understood that depending on the design of the engine 12, other quantities of spark plugs 34 may be used. For example, in compression-ignition engines, such as diesel engines and gasoline compression ignition engines, no spark plugs 34 are used at all. In another example, to more precisely control the combustion of air 20 and fuel 26 in the cylinder 18, the engine 12 may have 3 or more spark plugs 34 installed. The ignition timing, that is, the determination of the timing during which each spark plug 34 generates a spark is controlled by an ignition controller 36. The ignition controller 36 is a non-generalized electronic control device having a preprogrammed digital computer or processor 38, a memory or non-transitory computer readable medium 40 used to store data such as control logic, instructions, lookup tables, etc., and a plurality of input/output peripherals or ports 42. The processor 38 is configured to execute the control logic or instructions. The ignition controller 36 may have additional processors 38 or additional integrated circuits in communication with the processor 38 such as logic circuits for analyzing and determining an ignition spark timing for each spark plug 34 equipped to the engine 12.

Once the air 20 and fuel 26 have been combined and ignited by the spark plugs 34, exhaust gas 44 exits the cylinders 18 and enters the exhaust tract 46. The exhaust tract 46 is a series of pipes 48 through which exhaust 44 passes as the exhaust 44 is evacuated from the powertrain system 10. More specifically, the exhaust 44 flows through an exhaust manifold 50 before entering a catalytic converter 52. The catalytic converter 52 is an exhaust treatment device that provides reaction sites and catalyst material 54 that chemically alters chemical constituents of the exhaust 44 to reduce the environmental impact of the exhaust 44. In some examples, the powertrain system 10 includes a single catalytic converter 52, while in other examples, the powertrain system 10 includes a plurality of catalytic converters 52. Additionally, the catalytic converter 52 can include a variety of catalyst material 54 substrates designed to interact with specific exhaust 44 chemical constituents. Once the exhaust 44 has passed through the catalytic converter 52, the exhaust 44 passes through a tailpipe 56 and exits the powertrain system 10 into the atmosphere.

In some examples, the powertrain system 10 also includes an electric machine or motor 58 and a battery 60 providing electrical energy to the electric motor 58. The electric motor 58 is operable in each of a motor mode and a generator mode. In the motor mode, the electric motor 58 is powered by the battery 60 and drives the transmission 14, or in some examples, the wheels of a motor vehicle directly. In the generator mode, the electric motor 58 is used to charge the battery 60. It should also be evident that the battery 60 can power other vehicle accessories in addition to the electric motor 58. In some examples, the ignition controller 36 generates a command that directs electrical energy from the battery 60 to the spark plugs 34, thereby generating a spark.

The powertrain system 10 is managed by a powertrain control module (PCM) 62. Like the ignition controller 36, the PCM 62 is a non-generalized electronic control device having a preprogrammed digital computer or processor 38′, a memory or non-transitory computer readable medium 40′ used to store data such as control logic, instructions, lookup tables, etc., and a plurality of input/output peripherals or ports 42′. The processor 38′ is configured to execute the control logic or instructions. The PCM 62 may have additional processors 38′ or additional integrated circuits in communication with the processor 38′ such as logic circuits for analyzing an efficiency at which potential energy in the fuel 26 is converted into torque by the engine 12. The PCM 62 controls the operation of the powertrain system 10 by receiving input data from a plurality of sensors placed throughout the powertrain system 10, analyzing the input data, and generating responses to the input data. The responses to the input data are sent to a plurality of actuators placed throughout the powertrain system 10.

In one aspect, a quantity and volume of air 20 is measured by several of the plurality of sensors placed in an intake tract 64 of the engine 12. The sensors in the intake tract 64 include a mass airflow sensor (MAF) 66, an intake air temperature sensor (IAT) 68, and a manifold absolute pressure sensor (MAP) 70. The MAF 66 measures a mass of air 20 passing through the intake tract 64 and into the engine 12. The IAT 68 measures a temperature of the air 20 passing through the intake tract 64 and into the engine 12. The MAP 70 measures a pressure of air 20 within the intake manifold 24. It should be understood that depending on the design parameters of the engine 12, the intake tract 64 may be equipped with some or all of the MAF 66, IAT 68 and MAP 70, and that in some examples, the intake tract 64 may include multiple MAFs 66, IATs 68, and/or MAPs 70. Moreover, in some examples, some or all of the functionality of the MAF 66, IAT 68, and/or MAP 70 may be combined into a single piece of sensor hardware. For example, MAF 66 and the IAT 68 functionality can be combined into a single sensor. In addition, a throttle position sensor (TPS) 72 is disposed in the throttle 22 and determines and sends throttle position data to the PCM 62.

The exhaust tract 46 is equipped with at least one exhaust sensor 74. In one aspect, the exhaust sensor 74 is mounted in the flow of exhaust 44 prior to the catalytic converter 52. In some examples, the exhaust sensor 74 senses an oxygen (O2) content of the exhaust 44. In other examples, the exhaust sensor 74 senses a temperature of the exhaust 44. In still other examples the exhaust sensor 74 performs both O2 and temperature measurements of the exhaust 44.

The powertrain system 10 is also equipped with a fuel sensor 76. In one aspect, the fuel sensor 76 measures a specific gravity of the fuel 26. In another aspect, the fuel sensor 76 measures a temperature of the fuel 26. While the fuel sensor 76 has been described as having the ability to measure specific gravity or temperature of the fuel 26, depending on the design requirements of the powertrain system 10, the fuel sensor 76 may perform both specific gravity and temperatures measurements of the fuel 26 in the fuel lines 30.

The PCM 62 receives sensor data from at least the MAF 66, IAT 68, MAP 70, TPS 72, exhaust sensor 74, and fuel sensor 76. The control logic, instructions, and lookup tables stored within the memory 58 of the PCM 62 then manipulates the sensor data and generates output data that is used to control the powertrain system 10. That is, the output data is sent to the plurality of actuators to control how the powertrain system 10 functions. In one aspect, the PCM 62 generates output data that controls a position of the throttle 22, determines a volume and pressure of fuel 26 to inject into the engine 12 via the injectors 32, and controls an ignition timing of the spark plugs 34 via the ignition controller 36. In several aspects, the PCM 62 also generates output data that controls an operating mode of the electric motor 58 directly, or via the ignition controller 36.

A motor vehicle operator (not shown) manipulates an accelerator pedal 78 to regulate the throttle 22. More particularly, an accelerator pedal position sensor (APP) 80 generates a pedal position signal that is communicated to the PCM 62. The PCM 62 generates a throttle control signal based on the APP 80 signal. A throttle actuator (not shown) adjusts the throttle 22 based on the throttle control signal to regulate air 20 flow into the engine 12.

The vehicle operator also manipulates a brake pedal 82 to regulate vehicle braking. As the brake pedal 82 is actuated, a brake position sensor (BPP) 84 generates a brake pedal 82 position signal that is communicated to the PCM 62. The PCM 62 generates a brake control signal based on the BPP 84 signal. A brake system (not shown) adjusts vehicle braking based on the BPP 84 signal to regulate vehicle speed. In addition to the APP 80 and the BPP 84, an engine speed sensor 86 generates a signal based on engine speed. Moreover, based at least in part on signals from the APP 80, BPP 84, and engine speed sensor 86, the PCM 62 commands actuators in the powertrain system 10 to operate in a predetermined or programmed matter.

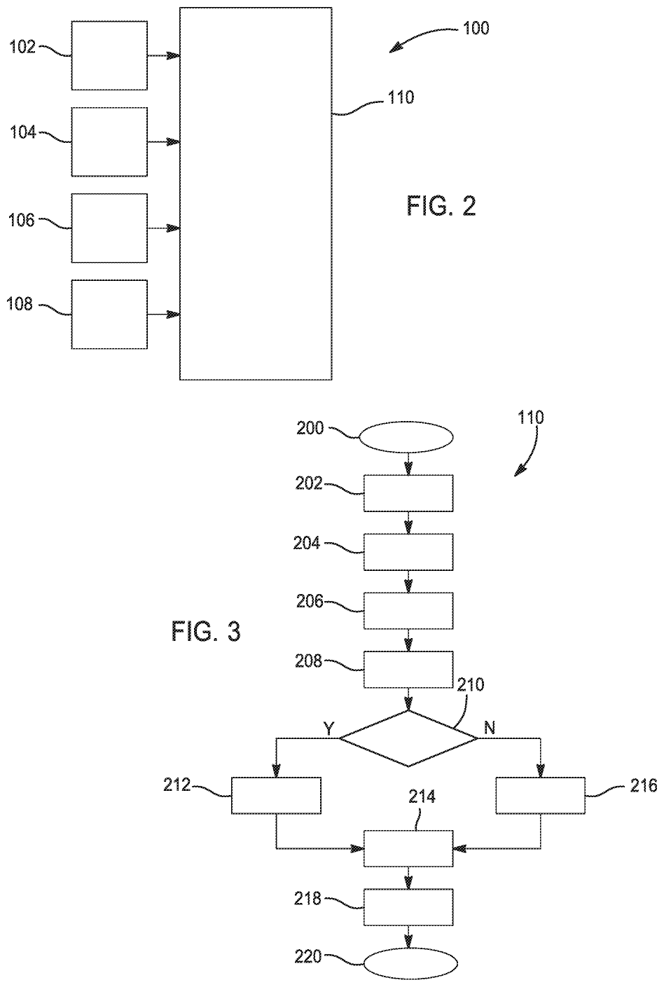

Turning now to FIG. 2, and with continuing reference to FIG. 1, a partial method for estimating a combustion efficiency of the engine 12 is shown and indicated generally by reference number 100. At block 102, the exhaust sensor 74 senses an O2 content of the exhaust. At block 104, the MAF 66 senses a mass of air 20 entering the engine 12. At block 106, the IAT 68 senses a temperature of the air 20 entering the engine 12. When taken in combination with the MAF 66 reading, the IAT 68 can be used to determine an oxygen content of the air 20 entering the engine 12, based on known densities and oxygen contents of air 20 at known temperatures, and the like. At block 108, the fuel sensor 76 determines a temperature of the fuel 26 entering the engine 12. Like the oxygen content of air 20 at a given temperature, an amount of energy contained in a predetermined amount of fuel 26 can be determined by the quality (specific gravity) of the fuel 26 and the temperature of the fuel 26. At block 110, the PCM 62 collects the data sensed at blocks 102, 104, 106, and 108 and the processor 38′ determines a combustion efficiency estimation based on the data and the programmatic logic stored in the memory 40′ of the PCM 62.

Turning now to FIG. 3, and with continuing reference to FIGS. 1 and 2, a method of continuously generating the combustion efficiency estimation carried out at block 110 of FIG. 2 is described in more detail. The method begins at block 200. At block 202, a quantity of air 20 entering the engine 12 is determined. As described previously, the MAF 66, IAT 68, and in some applications, the MAP 70 read characteristics of the air 20 entering the engine 12 and the PCM 62 determines a total amount of air, and more specifically, oxygen entering the engine 12 based on the MAF 66, IAT 68, and MAP 70 readings. At block 204 a quantity of oxygen in the exhaust 44 is sensed by the exhaust sensor 74. The method then proceeds to block 206 where the temperature of the air 20 entering the intake tract 64 is measured by the IAT 68.

At block 208, the PCM 62 uses the data from the MAF 66, IAT, 68, MAP 70, and exhaust sensor 74, or more broadly from the sensors in the intake tract 64, the exhaust tract 46, and the fuel sensor 76, to generate an estimate of a quantity of fuel 26 to inject into the engine 12. The estimate of a quantity of fuel 26 to inject follows the formula below:

$$\frac{{\dot{m}}_{air}}{λ} \cdot \frac{1}{{λ}_{ST} \times ρ} \qquad ( 1 )$$

where \dot{m}ₐᵢᵣ is the mass of air 20 entering the engine 12, λ is the current air-fuel ratio, λ_{ST} is the ideal stoichiometric air-fuel ratio of about 14.7:1, and ρ is the density of fuel 26 as sensed by the fuel sensor 76.

At block 210 the PCM 62 determines whether the motor vehicle operator has made a torque request, and whether the powertrain system 10 is in a load condition. In other words, the PCM 62 determines whether the (APP) 80 is indicating that a torque request has been made. If the operator has made a torque request, the combustion efficiency estimation 110 proceeds to block 212 where the PCM 62 calculates a load energy term. In several aspects, the load energy term is a measure of an amount of thermal energy or heat that is being delivered to the cylinders 18, and more specifically to combustion chambers of the cylinders 18 of the engine 12. In several aspects, the load energy term is a calculated value that the PCM 62 uses in subsequent calculations to adapt operation of the powertrain system 10 to sensor aging effects and drift over time. The load energy term is a measure of the heat delivered to the combustion chamber as a function of the oxygen content of the air 20 and the amount of fuel 26 entering the engine 12 weighted with a gain and integrated as a function of engine revolution. The gain is a factor, used in the calculation of a combustion efficiency index, to consider only the fuel 26 contribution to introducing thermal energy or heat into the combustion chambers of the cylinders 18 of the engine 12. The actual amount of fuel 26 injected is estimated indirectly via the MAF 66 and oxygen concentration in the exhaust 44 by reversing a stoichiometric formula for diesel combustion. The combustion efficiency estimation then proceeds to block 214 where the PCM 62 calculates a combustion efficiency index which will be described in greater detail below.

If, however, at block 210, the PCM 62 determines that the motor vehicle operator has not made a torque request, and that the engine is in a throttle-off or “dragged” condition, the method proceeds to block 216. When the engine 12 is in a throttle-off or “dragged” condition, the powertrain system 10 operates in a deceleration fuel cut-off (DCFO) mode. When the powertrain system 10 is in a DCFO mode, the supply of fuel 26 to the engine 12 is shut off, thereby reducing the amount of thermal energy or heat being delivered to the engine 12. At block 216, the PCM 62 calculates a dragged energy term. In several aspects, the dragged energy term, like the load energy term is a calculated value that the PCM 62 uses in subsequent calculations to adapt operation of the powertrain system 10 to sensor aging effects and drift over time. The dragged energy term is a measure of the thermal energy or heat removed from the cylinders 18 of the engine as a function of the mass of air 20 and temperature of the air 20 passing into the engine 12, weighted with a gain and integrated as function of engine 12 revolution. As described above, the gain is a factor, used in the calculation of the combustion efficiency index, to consider only the fuel 26 contribution to introducing thermal energy or heat into the combustion chambers of the cylinders 18 of the engine 12. Having calculated the dragged energy term, the method proceeds to block 214 where the PCM 62 calculates the combustion efficiency index.

The combustion efficiency index is an integral of the load energy term and the dragged or DFCO energy term with a correction factor applied. In several aspects, the correction factor is a latent heat of the fuel 26, leading to the following equation:

∫(Load−DFCO)dθ+Fuel Latent Heat (2).

Thus, when the operator has made a torque request, and the powertrain system 10 is operating in the load condition, the combustion efficiency index is weighted in favor of the amount of energy entering the powertrain system 10 from the fuel 26, whereas when the powertrain system 10 is operating in the dragged condition, the combustion efficiency index is weighted in favor of the amount of energy leaving the powertrain system 10 in the form of heat. The combustion efficiency index calculated at block 214 allows the PCM 62 to account for sensor and/or actuator aging and/or drift.

As sensors and actuators in the powertrain system 10 age, such sensors and actuators can drift away from their originally specified calibrations. As a result, the accuracy and precision of sensors and actuators in the powertrain system 10 can decrease as the sensors and actuators age. Therefore, it is desirable for the PCM 62 to account for aging effects and calibration drift when receiving input data from sensors and actuators, and when directing actuators within the powertrain system 10 to perform functions. Small quantity adjustment (SQA) strategies aid in providing the PCM 62 with a means to account for and adjust to sensor and actuator aging effects and drift. In one example, SQA measures a quantity of drift of a fuel injector 32 in a small quantity area by analyzing, during DCFO, the acceleration of the engine 12, and more specifically the acceleration of a crank wheel (not shown) of the engine 12. The acceleration of the crank wheel is directly associated with the combustion of a known quantity of fuel 26 within a single cylinder 18. In order to measure only a differential quantity error of the fuel injector 32, SQA must be performed under repeatable combustion conditions. The combustion efficiency index and the method for estimating the combustion efficiency of the engine 12 provide a means to create such repeatable combustion conditions. In another example, SQA can be used to measure a quantity of drift of a fuel injector 32 in a small quantity area by analyzing during DFCO, the acceleration of the crank wheel of the engine 12. As with the DCFO example, the acceleration of the crank wheel is directly associated with the combustion of a known quantity of fuel 26 within a single cylinder 18.

Referring once more to the method for estimating combustion efficiency, once the PCM 62 has calculated the combustion efficiency index, the method proceeds to block 218 where the PCM 62 adjusts adjusting a fuel injection quantity and commands the injector 32 or injectors 32 to inject fuel 26 into the engine 12. At block 220 the method ends and returns back to block 200 where the method runs continuously.

A method for evaluating the instantaneous fuel to torque efficiency of an internal combustion engine of the present disclosure offers several advantages. These include the ability to automatically, and continuously respond to sensor and actuator aging effects and calibration drift in real time. The method also uses existing hardware and data connections, thereby reducing cost and improving reliability, creating redundancy, and maintaining regulatory compliance. The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of determining combustion efficiency in an internal combustion engine (ICE) comprises:
utilizing a control module having a plurality of inputs, a plurality of outputs, a computer readable memory, and a processor, the processor configured to execute programmatic logic stored within the computer readable memory;
sensing data by a first plurality of sensors disposed on the ICE and electrically connected to the plurality of inputs of the control module, and by a second plurality of sensors electrically connected to the plurality of inputs of the control module and disposed in an exhaust system fluidly coupled to the ICE;
receiving within the control module data sensed by the first and the second plurality of sensors;
determining an oxygen (O2) content of air entering the ICE and determining an O2 content of exhaust upstream of an oxidation catalyst;
determining a latent heat of vaporization of fuel;
determining a fuel injection quantity required to be combusted with the O2 sensed in the air entering the ICE;
determining a combustion efficiency index based on the O2 content of the air entering the ICE, the O2 content of the exhaust upstream of the oxidation catalyst, and the latent heat of vaporization of the fuel; and
adjusting a fuel injection quantity.

2. The method of claim 1 wherein determining an O2 content of air entering the ICE further comprises utilizing a mass air flow sensor of the first plurality of sensors to detect an amount of air entering the ICE.

3. The method of claim 1 wherein determining an O2 content of air entering the ICE further comprises utilizing a manifold absolute pressure (MAP) sensor of the first plurality of sensors to detect an amount of air entering the ICE.

4. The method of claim 1 wherein determining an O2 content of the exhaust further comprises utilizing an oxygen sensor of the second plurality of sensors to detect an O2 content of the exhaust upstream of the oxidation catalyst.

5. The method of claim 1 wherein determining a latent heat of vaporization of the fuel further comprises utilizing a fuel temperature sensor of the first plurality of sensors, the fuel temperature sensor disposed in a fuel line of the ICE to sense a temperature of the fuel entering the ICE.

6. The method of claim 1 further comprising determining a load condition of the ICE.

7. The method of claim 6 wherein determining a load condition of the ICE further comprises receiving an input from several of the first plurality of sensors, including a throttle position sensor (TPS), and an accelerator pedal position (APP) sensor, and determining whether the ICE is operating in a loaded condition or in a cut-off condition.

8. The method of claim 7 wherein determining a load condition of the ICE further comprises determining whether a combustion chamber temperature is above a predetermined threshold temperature as a function of intake temperature, mass air flow, and exhaust gas temperature.

9. The method of claim 8 wherein when the engine is operating in a loaded condition, calculating a gain by integrating an actual fuel injection quantity as a function of engine revolution, wherein the actual fuel injection quantity is estimated as a function of mass air flow and O2 concentration in the exhaust.

10. The method of claim 8 wherein when the engine is operating in a cut-off condition, calculating a gain by integrating an actual fuel injection quantity as a function of engine revolution, wherein the actual fuel injection quantity is zero and the gain is a function of mass air flow and intake air temperature.

11. A system for determining combustion efficiency in an internal combustion engine (ICE) comprises:
a control module executing control logic and having a plurality of inputs and a plurality of outputs;
the plurality of inputs and the plurality of outputs electronically connected to a first plurality of sensors and actuators disposed on the ICE, and the plurality of inputs and the plurality of outputs electronically connected to a second plurality of sensors and actuators disposed on an exhaust system fluidly coupled to the ICE
the control logic comprising:
a first control logic for receiving data sensed by the first and the second plurality of sensors and actuators;
a second control logic for determining an oxygen (O2) content of air entering the ICE and determining an O2 content of exhaust upstream of an oxidation catalyst;
a third control logic for determining a latent heat of vaporization of fuel;
a fourth control logic for determining a combustion efficiency index based on the O2 content entering the IC, the O2 content of the exhaust upstream of the oxidation catalyst, and the latent heat of vaporization of the fuel; and
a fifth control logic for adjusting a fuel injection quantity based on the combustion efficiency index.

12. The system of claim 11 wherein the second control logic further comprises utilizing a mass air flow sensor (MAF) or a manifold absolute pressure (MAP) sensor to detect an amount of air entering the ICE.

13. The system of claim 11 wherein the second control logic further comprises utilizing an oxygen sensor to detect an O2 content of the exhaust upstream of the oxidation catalyst.

14. The system of claim 11 wherein the third control logic further comprises utilizing a fuel temperature sensor disposed in a fuel line of the ICE to sense a temperature of the fuel entering the ICE.

15. The system of claim 11 further comprising a sixth control logic determining a load condition of the ICE.

16. The system of claim 15 wherein the sixth control logic further comprises receiving an input from a throttle position sensor (TPS) and an accelerator pedal position (APP) sensor, and determining whether the ICE is operating in a load condition or in a cut-off condition.

17. The system of claim 16 wherein the sixth control logic further comprises determining whether a combustion chamber temperature is above a predetermined threshold temperature as a function of intake air temperature, mass air flow, and exhaust gas temperature.

18. The system of claim 17 wherein the sixth control logic further comprises when the ICE is operating in the load condition, calculating a gain by integrating an actual fuel injection quantity as a function of engine revolution, wherein the actual fuel injection quantity is estimated as a function of mass air flow and O2 concentration in the exhaust.

19. The system of claim 17 wherein the sixth control logic further comprises when the ICE is operating in a cut-off condition, calculating a gain by integrating an actual fuel injection quantity as a function of engine revolution, wherein the actual fuel injection quantity is zero and the gain is a function of mass air flow and intake air temperature.

20. A system for determining combustion efficiency in an internal combustion engine (ICE) of a propulsion system comprises:
a control module executing control logic and having a plurality of inputs and a plurality of outputs;
the plurality of inputs and the plurality of outputs electronically connected to a first plurality of sensors and actuators disposed on the ICE, and the plurality of inputs and the plurality of outputs electronically connected to a second plurality of sensors and actuators disposed on an exhaust system fluidly coupled to the ICE
the control logic comprising:
a first control logic for receiving data sensed by the first and the second plurality of sensors and actuators;
a second control logic for utilizing a mass air flow sensor (MAF) or a manifold absolute pressure sensor (MAP) to determine an oxygen (O2) content of air entering the ICE and for utilizing an oxygen sensor to detect an O2 content of the exhaust upstream of the oxidation catalyst;
a third control logic for utilizing a fuel temperature sensor disposed in a fuel line of the ICE to sense a temperature of fuel entering the ICE and for determining a latent heat of vaporization of the fuel;
a fourth control logic for determining a combustion efficiency index based on the O2 content entering the IC, the O2 content of the exhaust upstream of the oxidation catalyst, and the latent heat of vaporization of the fuel;
a fifth control logic for adjusting a fuel injection quantity based on the combustion efficiency index;
a sixth control logic for receiving an input from a throttle position sensor (TPS) and an accelerator pedal position (APP) sensor, and determining whether the ICE is operating in a load condition or in a cut-off condition, wherein when the ICE is operating in a load condition, calculating a gain by integrating an actual fuel injection quantity as a function of engine revolution, wherein actual fuel injection quantity is estimated as a function of mass air flow and O2 concentration in the exhaust; and
a seventh control logic for determining whether a combustion chamber temperature is above a predetermined threshold temperature as a function of intake air temperature, mass air flow, and exhaust gas temperature.
